(19) United States
(12) Patent Application Publication
(10) Pub. No.: US 2010/0092215 A1
(43) Pub. Date: Apr. 15, 2010

(54) PRINTING SYSTEM WITH TONER BLEND

(75) Inventors: Richard P.N. VEREGIN, Mississauga (CA); Karen A. MOFFAT, Brantford (CA); Dale R. MASHTARE, Bloomfield, NY (US); Daryl W. VANBESIEN, Burlington (CA); Jordan H. WOSNICK, Toronto (CA); Cuong VONG, Hamilton (CA); Eric STROHM, Oakville (CA); Maria N.V. MCDOUGALL, Oakville (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 12/249,327

(22) Filed: Oct. 10, 2008

(51) Int. Cl. G03G 15/01

(52) U.S. Cl. 399/223

(57) ABSTRACT

An improved electrostatic printing method includes printing a first marking material, such as a fully colorized toner, and also printing a second marking material on the same area of the print substrate. The second marking material is a mixture of two toners, where at least one of the two toners has a lower color strength than the first marking material. The second marking material has the same hue as the first marking material, and the ratio of toners in the mixture is such that the second marking material has a color strength matching that of an undesirable optical density printing rage of the first marking material.

### TECHNICAL FIELD

This disclosure is generally directed to improved methods of electrostatic printing using at least two toners of the same hue printed on the same area of a printed image, where one of the two toners is a mixture of a low color strength toner and a higher color strength toner.

### BACKGROUND

Generally, an electrophotographic printing machine includes a photoconductive member that is charged to a substantially uniform potential to sensitize the surface thereof. The charged portion of the photoconductive member is exposed to an optical light pattern representing the document being produced. This records an electrostatic latent image on the photoconductive member corresponding to the informational areas contained within the document. After the electrostatic latent image is formed on the photoconductive member, the image is developed by bringing a developer material into proximal contact therewith.

Typically, the developer material comprises toner particles adhering triboelectrically to carrier granules. The toner particles are attracted to the latent image from the carrier granules and form a powder image on the photoconductive member, which is subsequently transferred to a copy sheet. Finally, the copy sheet is heated or otherwise processed to permanently affix the powder image thereto in the desired image-wise configuration.

For example, a color image forming apparatus for forming a color image by an electrophotographic system, prints and superposes respective toner images of the four colors of yellow (Y), magenta (M), cyan (C) and black (K) successively on a sheet of paper, which serves as a recording medium, to thereby form a color image. The density of each color toner image is reproduced as a set of a large number of fine halftone dots.

In halftone printing, each color separation is represented by dots. Each dot can be made up of a number of pixels or elements, usually arranged in a grid, which are binary in the sense they can be either fully on or fully off. Part of the processing of input digital images, in which pixels may be defined on a continuous tone image, includes determining which pixels of each dot of the image should be on and which off. Typically, a mask is used which specifies for each color level which pixels of the dot are on and which are off. As more pixels are turned on, the size of the dot increases and its apparent color intensity to the eye increases. One-dimensional Tone Reproduction Curves (TRCs) are widely used in digital imaging as a means for compensating for non-linearities in the halftone color density introduced by an imaging device.

Halftone noise is the visible distortion of the printed image arising from instabilities in the processing of the halftone dots. Further, under certain printing conditions, dependent upon ink color and halftone dot dimensions, the human eye can see the contrast between the color of the individual halftone dots and the white space of the recording medium, such as paper. Even as perfectly rendered, this visible halftone dot structure can be perceived as objectionable image structure, and becomes a noise in the desired image. Halftone noise is particularly visible throughout the highlight and the midtone levels of the TRC, such as would occur in a blue sky or fleshtones, for example. Furthermore, halftone noise is especially visible when the halftone dots are black, magenta or cyan in color.

Additionally, rendition of the halftone dots can be adversely effected by variations in process and material properties, resulting in perceptible variations, both spatially and temporally. Such variations are generally referred to as printer noises, and further detract from printed image quality in addition to halftone noise.

One known method of alleviating halftone noise is the use of a lightly colorized toner in conjunction with a fully colorized toner. Specifically, a printing system can alleviate halftone noise by printing a fully colorized toner, having a high colorant concentration, while also printing a lightly colorized toner, having a lower colorant concentration. In such an approach, for example, the lightly colorized toner is used to print the highlight areas of the image, while the fully colorized toner prints the rest of the image. Halftone noise is thereby reduced because the lightly colorized toner need not be printed in as many separate individual halftone dots to achieve the same color level; and because the contrast between the color of the dots, being lightly colorized, and the color of the recording medium is lessened. For example, U.S. Pat. No. 6,596,065 to Ito et al. describes a black and gray ink applied in an inkjet system to render image with reduced graininess evaluated as dot visibility; or U.S. Pat. No. 6,013,403 to Ichikawa describes use of black and grey toner to achieve reduced graininess print rendering; or U.S. Pat. No. 7,288,356 to Ayaki et al. describes deep and pale toners to result in “suppressing graininess and roughness over the areas covering from the low density area to the high density area.”

However, this approach does not adequately alleviate halftone noise in areas other than the highlight areas printed with the lightly colorized toner. Furthermore, this approach requires formulation of a separate a lightly colorized toner for each color. Thus, for each of the CMK color toners, three lightly colorized toners would also need to be produced, a light cyan, a light magenta, and a gray toner. Optionally, a light yellow could also be required, though image noise is usually not very visually objectionable for yellow.

Accordingly, there is a need for an improved electrostatic printing method that can alleviate halftone noise and printer noises in an efficient and cost-effective manner

### SUMMARY

The present disclosure addresses these and other needs, by providing an improved printing method for alleviating halftone noise. More particularly, this disclosure provides an improved printing method wherein at least one colorized toner and at least one mixture of a colorized toner and a toner having a lower color strength are printed on the same area of a print substrate.

In embodiments, this disclosure provides a method of printing an image comprising printing at least one first marking material on an area of a substrate, the at least one first making material comprising a first toner having a first hue; and printing at least one second marking material on the same area of the substrate; wherein the at least one second marking material comprises a mixture of at least a second and a third toner, where at least one of the second or third toner has a lower color strength than the first marking material, and the second marking material having a hue that is the same hue as the first hue; and wherein a ratio of the second toner to the third toner in the second markings material results in the second marking, material having a color strength matching that of an undesirable optical density printing range of the first marking material.

### BRIEF DESCRIPTION OF THE DRAWINGS

FIG. 1 illustrates an exemplary five-color electrostatic printing device.

FIGS. 2A, 2B, 2C and 2D illustrate the results of mixing a 50:50 mixture of emulsion aggregation green toner prepared with 11% Pigment Green 7 and an emulsion aggregation clear toner.

FIGS. 3A, 3B, 3C, 3D illustrate the results of mixing an emulsion aggregation yellow toner prepared with 17% Pigment Yellow 14 and an blue toner prepared with 7% Pigment Blue 15.3 having different triboelectric charges.

FIG. 4A illustrates the differing triboelectric charges of emulsion aggregation yellow toner prepared with 17% Pigment Yellow 14 and an emulsion aggregation blue toner prepared with 7% Pigment Blue 15.3 and their mixture.

### DETAILED DESCRIPTION OF EMBODIMENTS

This disclosure is not limited to particular embodiments described herein, and some components and processes may be varied by one of ordinary skill in the art, based on this disclosure. The terminology used herein is for the purpose of describing particular embodiments only, and is not intended to be limiting.

In this specification and the claims that follow, singular forms such as “a,” “an,” and “the” include plural forms unless the content clearly dictates otherwise. In addition, reference may be made to a number of terms that shall be defined as follows:

The phrase L*a*b values means the three parameters (L, a and b) which define a color space according to the Commission Internationale de l'Eclalrage (“CIELAB”). The values represent the luminance of the color (L, L=0 yields black and L=100 indicates white), its position between red and green (a, negative values indicate green, while positive values indicate red) and its position between yellow and blue (b, negative values indicate blue and positive values indicate yellow).

The phrase dE2000 indicates that the standard CIEDE2000 formula has been calculated to provide a dE2000 value, which measures the color difference between two colors. The larger the dE value, the larger the color difference. A dE of 1.5 to 2 is generally considered to be at the limit of visual perception. The formula was published by the CIE in 2001.

The phrase q/d means the charge to diameter ratio, the ratio of the charge on a particle, to the size of the particle, for example where the particle is a toner. The q/d is normally measured in fC/μm. The measurement of the average q/d of the toner particles can be done by means of a charge spectrograph apparatus as well known in the art. See, for example, U.S. Pat. No. 4,375,673, incorporated herein by reference. The spectrograph is used to measure the distribution of the toner particle charge (q in fC) with respect to a measured toner diameter (d in μm). In the charge spectrograph the charge can also be conveniently measured in mm displacement from a zero charge spot. In this application, the displacement in mm can be converted to a q/d in fC/micron by multiplying by 0.092.

An improved printing method for alleviating halftone noise includes printing a first marking material, comprising for example a fully colorized toner, and printing a second marking material that comprises a mixture of two toners on the same area of a print substrate, where at least one of the two toners in the mixture has a lower color strength than the first making material. The first and second marking materials have the same hue, and the ratio of toners in the mixture is such that the mixture achieves a color strength that is within an undesirable optical density printing range of the first marking material.

The terms “first making material” and “second marking material” as used herein can refer to one or more than one such specific marking material. For example, each of a cyan, yellow, magenta and black marking materials can be considered as “first marking materials,” while one or several mixtures of toners are collectively referred to as “second marking materials.”

The method can be conducted using any known electrostatic printing apparatus having the requisite number of developer housings. In various exemplary embodiments for full-color printing, the printing apparatus has five developer housings, one each to contain cyan, yellow, magenta, black toners and one to contain the second marking material. In another embodiment, the printing apparatus can have six developer housings, one each to contain cyan, yellow, magenta, black, a second marking material including (for example) cyan and clear toners, and a second marking material including (for example) magenta and clear toners. In such an embodiment, the printing method thereby includes four first marking materials and two second marking materials. In yet another embodiment, the printing apparatus can have eight developer housings, one each to contain cyan, yellow, magenta and black, and one each to contain mixtures of each of the forgoing with a toner having a lower color strength. This printing method therefore includes four first marking materials and four second marking materials.

Other printer embodiments could employ even more first or second marking materials, based on the color separations applied in the specific print architecture. In other embodiments, such as for monochrome printing, the printing device has just two developer housings, one containing black toner and one containing the second marking material. Each developer housing retains a quantity of developer made up of carrier particles and toner particles.

In printing methods including more than one second markings material, each of the second marking materials has a hue that is the same as one of the first marking materials. These second marking materials are then printed on the same area of the print substrate as the corresponding first marking material have the respective same hue. Specifically, for example, in a full color image printing method, a second marking material comprising a mixture of cyan and clear toners is printed on the same area of the print substrate as the first marking material having a cyan hue, while a second marking material comprising a mixture of magenta and clear toners is printed on the same area of the print substrate as the first marking material having a magenta hue.

The second marking material can be printed in any proportion to the first marking material, according to the image data. Specifically, the printing method can print the second marking material as a continuous solid area if the color of the image data is the same color as the color strength of the second marking material. Alternatively, the printing method can print the second marking material as halftone dots if the color strength of the image data is of a lighter intensity than the color strength of the second marking material. Finally, the printing method can also print the second marking material as a halftone up to a specific color level on the TRC (tone reproduction curve) corresponding to the color strength of the second marking material, then as a solid area thereafter.

In all of the forgoing, the first marking material may also be printed as a halftone in the same area printed with the second marking material, in order to achieve color levels on the TRC that are darker than the color strength of the second marking material. It will be necessary to construct full dynamic range of the color separation in such a manner to insure smooth tone gradations from 0% area coverage to the fully saturated color. This requires that the combinations of first marking material and second marking material is done to minimize any visual effects occurring at the transitional regions where application of one marking material begins and another ends. Likewise, combinations of the color separations to render multiple separation color combinations will also be combined in such a manner render smooth color gradations. The printing method can be conducted using a printing apparatus that includes a controller for determining the proportions and patterns of the first and second marking materials according to the image data.

The first marking material comprises a first toner having a first hue. The first toner can be any electrostatic toner having a concentration of colorant sufficient to produce a standard process or spot color. The term “colorant” refers for example to such organic soluble dyes, pigments, and mixtures, unless specified as a particular pigment or other colorant component. In embodiments, the colorant comprises carbon black, magnetite, black, cyan, magenta, yellow, red, green, blue, brown, or mixtures thereof, in an amount of about 1% to about 25%, such as about 2% or about 5% to about 15% or about 20%, by weight based upon the total weight of the composition. It is to be understood that other useful colorants will become readily apparent based on the present disclosures. The first hue can be any particular hue, depending on the colorant present. The first toner generally includes a resin in addition to the colorant, as well as optional additives such as a wax, a coagulant, charge control agents, flow control agents and the like. A wide range of such colorized toner compositions are well known in the art.

The first toner, in embodiments, can be a toner made by any of the well known processes in the art. For example, the first toner can be a conventional toner, which is typically one that is made by forming a large mass of toner particle material, extruding that toner particle material, and grinding and classifying the extruded material into the desired toner particle size ranges. However, in other embodiments, the first toner can be a chemical toner, such as one made by the emulsion/aggregation process. The process of emulsion aggregation is well known in the art of toner production, and is known to produce fine toner particles having small diameters and generally a narrow particle size distribution. Emulsion aggregation processes for the preparation of toners are illustrated in a number of Xerox patents, such as U.S. Pat. Nos. 5,290,654, 5,278,020, 5,308,734, 5,370,963, 5,344,738, 5,403,693, 5,418,108, 5,364,729, and 5,346,797; and also of interest may be U.S. Pat. Nos. 5,348,832; 5,405,728; 5,366,841; 5,496,676; 5,527,658; 5,585,215; 5,650,255; 5,650,256 5,501,935; 5,723,253; 5,74,520; 5,763,133; 5,766,818; 5,747,215; 5,827,633; 5,853,944; 5,804,349; 5,840,462; 5,869,215; 5,869,215; 5,863,698; 5,902,710; 5,910,387; 5,916,725; 5,919,595; 5,925,488 and 5,977,210. The entire disclosures of these references are incorporated herein by reference. Fine toner particles, for example toner particles having a mean diameter of less than 7 microns, further help to reduce image noise by allowing the printing apparatus to place the halftone dots with better precision. This better precision results in less scattering of the toner in and around the halftone dots, thereby resulting in a better image quality.

The second marking material comprises a second toner and a third toner. Generally, at least one of the second and third toners has a lower color strength that the first marking material. In an embodiment, the second toner can be the same composition as the first toner in the first marking material, such as a fully colorized toner, or it can be a different composition. For example, where the third toner has electrical and other performance properties that closely match the first toner, then it may be desirable to use the same toner composition as the first and second toners. This would thereby avoid the need to develop different toner compositions of the same color, but instead would allow for dual use of the one already developed toner composition. Of course, in other embodiments the second toner can be a different composition from the first, such as where different properties, performance or color are desired.

The third toner can be a toner made of similar resins as the second toner, and containing all of the same optional additives such as flow and charge control agents, but containing a lower concentration of colorant. The third toner can be an emulsion aggregation toner, having a small toner particle diameter. For example, the third toner is desirably of the same chemical composition as the second toner, except that the colorant is changed by either reducing the pigment loading or by changing the pigment type, or both. In embodiments, when the third toner contains at least some colorant, the colorant and colorant loading is chosen so that the printed hue of the third toner matches the printed hue of the second toner, so that there is no color mismatch on the print. In other embodiments, the third toner is a clear toner, substantially lacking any colorant, such that it is optically clear and un-colored. In this embodiment, the clear toner adds no hue to the second toner color, so that the hue of the total mixture (i.e. second marking material) is the same as the hue of the second toner. Of course, either the second or the third toner may be the toner having the lower color strength.

The second marking material can be made by physically intermixing the second and third toners. In particular, the second marking material can be made by mixing a toner that has a standard full amount of colorant (such as the fully colorized toner described above) with a toner that has been manufactured with less colorant (for example, fewer or no colorant), or with a changed colorant, or with both less colorant and a changed colorant, where the two toners have similar triboelectric charge. It is important to note that such a mixture of colorized toner and toner having a lower color strength is not the same as a uniform toner composition having a proportionately lower colorant loading. In particular, as between two such toners, the apparent color of the two toner compositions, and in some cases their electrical properties, can be quite different.

The distribution of the triboelectric charges of the two mixed toners should substantially overlap, so that the two do not develop differently. A substantial difference in triboelectric charge will, for example, over time as the printing apparatus draws the toners at different rates, chance the relative populations of the two toners in the second marking material. The apparent color printed using the second marking material would then change, resulting in poor color accuracy and consistency. Therefore, the triboeletric charge distributions should be essentially identical, such that a visual measurement of the q/d in a charge spectrograph shows essentially complete overlap of the two colors, so that only the mixed color is visible. For good performance under a broad range of conditions, the triboelectric charge of the toner and developer should change as little as possible across various environmental conditions.

For emulsion aggregation toners, the triboelectric charges of toners using different pigments was found to be substantially the same. In other words, the pigment particles do not affect the triboelectric charge of emulsion aggregation toners. Therefore an emulsion aggregation toner of any color can be mixed with an emulsion aggregation toner having a lower color strength, so long as the additives and any optional charge control agent are the same. See Example 1 below.

Generally, the ratio of the second toner to the third toner in the second marking material result in the second marking material having a color strength matching that of a particularly instable region of the TRC and/or one in which the halftone dot is most objectionably visible if rendered with the first marking material alone. These regions of the TRC are substantially noise inducing regions, if rendered with the first marking material alone. In embodiments, the ratio can be adjusted depending on the print engine used or customer preference. For example, substantially noise inducing regions of the first marking material may fall within highlight to midtone range of the Toner Reproduction Curve, such as might occur in blue sky or fleshtone image areas. Finally, the substantially noise inducing region may comprise a peak noise range occurring as a result of the specific printing architecture, or even as may vary over the life cycle of components within the print engine. For example, some printing architectures result in peak noise regions in the highlight areas such as might occur in the 10-30% toner area coverage region while other printing architectures may demonstrate peak noise region more predominantly in the midtone areas such as might occur in the 30-70% area coverage region. Similarly this peak noise region can shift over the life cycle of components in the printing architecture. In this way, the ratio of toners making up the second marking material may be adjusted in such a way as to deliver a color strength at a particular point on the Toner Reproduction Curve so as to improve print image quality.

Specifically, the color strength of the second marking material may be controlled by varying the amount of toner having a lower color strength mixed with the fully colorized toner. In this way, any particular color strength can be achieved simply by mixing the two components. For example, instead of using a 1% pigment loading lightly colorized toner, an equivalent 1:5 blend of a 5% pigment loaded colorized toner to clear toner can be used instead. The advantage of this approach is that only one new toner, for example the clear toner, needs to be developed, manufactured and stored in order to provide the equivalent of a wide variety of lightly colorized toners.

This advantage was surprising and unexpected because a mixture of a colorized toner and a toner having a lower color strength is not structurally or chemically equivalent to a lightly colorized toner. A colorized toner particle is made up of colorant dispersed within a resin particle, with optional additives on the surface of the resin particle. In this way, a lightly colorized toner particle is made up of a resin particle containing less colorant therein. Therefore, lightly colorized toners are made up of many resin particles each having a uniform, reduced, amount of colorant therein. On the other hand, a mixture of a colorized toner and a toner having a lower color strength is made up of some resin particles having a full amount of colorant dispersed therein, and some resin particles having less colorant and optionally a chanced colorant, or even no colorant in some embodiments. This non-uniformity of the distribution of colorant within the resin particles therefore distinguishes the mixture of a colorized toner and a clear toner from known lightly colorized toners.

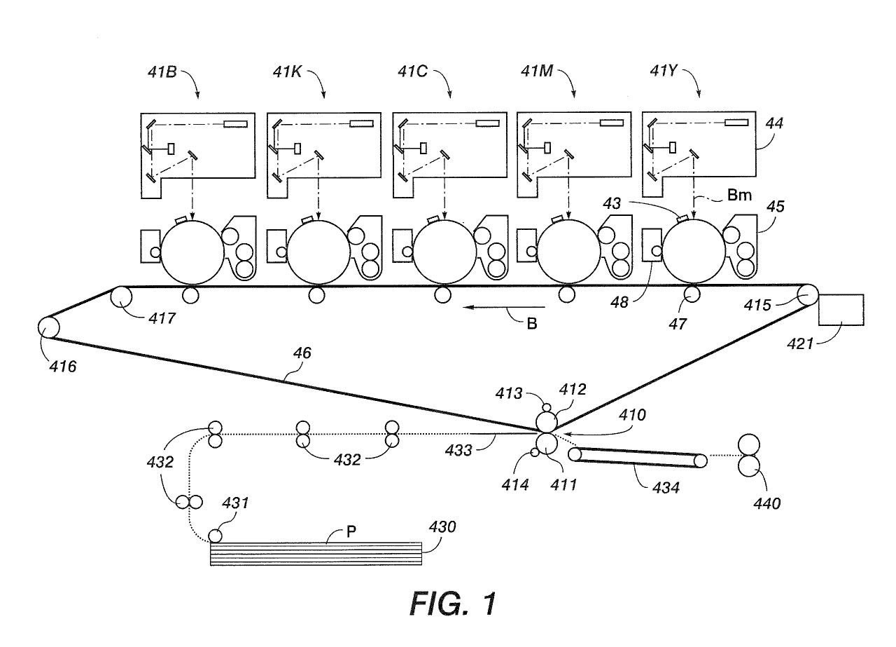

FIG. 1 shows an example of an image formation apparatus, in which the present image forming method can be conducted. The image formation apparatus is substantially as shown in U.S. Patent Application Publication No. 2007/0063047, the disclosure of which is hereby incorporated in its entirely.

The image formation apparatus shown in FIG. 1 is a tandem apparatus, it includes a plurality of image formation units 41 (41Y, 41M, 41C, 41K, and 41B) for forming toner images of color components electrophotographically, an intermediate transfer belt 46 for transferring the color component toner images formed in the image formation units 41 in sequence (primary transfer) and retaining the color component toner images, a secondary transfer unit 410 for transferring the overlap image transferred onto the intermediate transfer belt 46 onto paper (medium) P in batch (secondary transfer), and a fuser 440 for fixing the secondarily transferred image onto the paper P.

The image formation apparatus is provided with the image formation unit 41K for forming a black (K) toner image, as well as the image formation units 41Y, 41M, and 41C for forming toner images of yellow (Y), magenta (M), and cyan (C). The image formation unit 41B applies a second marking material. In this embodiment, the second marking material is a mixture of a clear toner and a cyan toner. However, in alternative embodiments, the second marking material is a mixture of a clear toner and a magenta toner, or a mixture of a clear toner and a black toner, or a mixture of a clear toner and a fully colorized toner having any other color.

In other alternative embodiments, the image formation apparatus can comprise additional image formation units, also referred to as housings. These additional housings can print additional second marking materials. For example, the image formation apparatus can comprise six housings, one for each of cyan, magenta, yellow, black, a mixture of clear toner and cyan toner, and a mixture of clear toner and magenta toner. In another embodiment, the image formation apparatus can comprise seven housings, one for each of cyan, magenta, yellow, black, a mixture of clear toner and cyan toner, a mixture of clear toner and magenta toner, and a mixture of clear toner and black toner. Finally, the image formation apparatus can comprise eight housings, one for each CMYK process color and one housing each for each mixture of a clear toner and each process color toner.

In the embodiment, in each of the image formation units 41 (41Y, 41M, 41C, 41K, and 41B), disposed in sequence surrounding a photoconductive drum 42 for rotating in the arrow A direction are electrophotographic devices such as a charger 43 for charging the photoconductive drum 42, a laser exposure device 44 for writing an electrostatic latent image onto the photoconductive drum 42 (in the figure, exposure beam is indicated by Bm), a developing device 45 in which the corresponding color component toner is stored for rendering the electrostatic latent image on the photoconductive drum 42 as a visible image in toner, a primary transfer roll 47 for transferring the color component toner images formed on the photoconductive drum 42 onto the intermediate transfer belt 46, and a drum cleaner 48 for removing the remaining toner on the photoconductive drum 42. The image formation units 41 are placed in the order of yellow (Y), magenta (M), cyan (C), black (K), and the light blended color (B) which in this embodiment is a blend of cyan and clear toner, upstream of the intermediate transfer belt 46.

The intermediate transfer belt 46 can be rotated in the arrow B direction shown in the figure by means of various rolls of a drive roll 415 for rotating the intermediate transfer belt 46 driven by a motor (not shown), a tension roller 416 having functions of giving constant tension to the intermediate transfer belt 46 and preventing the intermediate transfer belt 46 from meandering, an idle roll 417 for supporting the intermediate transfer belt 46, and a backup roller 412 (described later).

A voltage of the opposite polarity to the toner charge polarity is applied to the primary transfer roll 47, whereby the toner images on the photoconductive drum 42 are electrostatically attracted to the intermediate transfer belt 46 in order and an overlap toner image is formed on the intermediate transfer belt 46. Further, the secondary transfer unit 410 includes a secondary transfer roll 411 pressed against and placed on the toner image support side of the intermediate transfer belt 46 and a backup roller 412 placed on the back of the intermediate transfer belt 46 for forming a counter electrode of the secondary transfer roll 411. A metal feeding roll 413 to which a secondary transfer bias is stably supplied is abutted against and placed on the backup roller 412.

A belt cleaner 421 for cleaning the surface of the intermediate transfer belt 46 after secondary transfer is provided downstream from the secondary transfer roll 411.

Further, in the embodiment, a paper transport system includes a paper tray 430 for storing paper P, a pickup roller 431 for picking up and transporting paper P stacked on the paper tray 430 at a predetermined timing, a transport roll 432 for transporting the paper P paid out by the pickup roller 431, a transport chute 433 for feeding the paper P transported by the transport roll 432 into a secondary transfer position of the secondary transfer unit 410, and a transfer belt 434 for transporting the paper P after secondary transfer to the fuser 440.

Next, an embodiment of the method of printing an image using the exemplary image formation apparatus will be discussed. When the user turns on a start switch (not shown), a predetermined image formation process is executed. Specifically, for example, to implement the image formation apparatus as a color printer, a digital image signal transmitted from a network (not shown), for example, is temporarily stored in memory (not shown) and color toner images are formed based on the five-color (Y, M, C, K, and B) digital image signal.

That is, the image formation units 41 (41Y, 41M, 41C, 41K, and 41B) are driven based on color image record signals provided by performing image processing. Each of the image formation units 41Y, 41M, 41C, 41K, and 41B writes an electrostatic latent image responsive to the corresponding image record signal by the laser exposure device 44 onto the photoconductive drum 42 uniformly charged by the charger 43. The image formation unit develops the written electrostatic latent image by the developing device 45 in which the corresponding color toner is stored to form the toner image of the corresponding color.

The toner image formed on each photoconductive drum 42 is primarily transferred from the photoconductive drum 42 onto the surface of the intermediate transfer belt 46 according to a primary transfer bias applied by the primary transfer roll 47 at the primary transfer position where the photoconductive drum 42 and the intermediate transfer belt 46 are in contact with each other. The toner images thus primarily transferred onto the intermediate transfer belt 46 are overlapped on each other on the intermediate transfer belt 46 and are transported to the secondary transfer position with rotation of the intermediate transfer belt 46.

On the other hand, the paper P is transported to the secondary transfer position of the secondary transfer unit 410 at a predetermined timing and the secondary transfer roll 411 nips the paper P relative to the intermediate transfer belt 46 (backup roll 412). The overlap toner image supported on the intermediate transfer belt 46 is secondarily transferred onto the paper P by the action of a secondary transfer electric field formed between the secondary transfer roll 411 and the backup roll 412.

Then, the paper P onto which the toner image is transferred is transported over the transport belt 434 to the fuser 440 for fixing the toner image. On the other hand, the intermediate transfer belt 46 after the secondary transfer has the remaining toner removed by the belt cleaner 421.

### EXAMPLES

The disclosure will be illustrated in greater detail with reference to the following Example, but the disclosure should not be construed as being limited thereto. In the following example, all the “parts” are given by weight unless otherwise indicated.

### Example 1

The mean triboeletric charge of emulsion aggregation toners in 14 different Pantone™ primary colors, Pantone Black, Pantone Reflux Blue, Pantone Process Blue, Pantone Yellow, Pantone Yellow 012, Pantone Rubine Red, Pantone Warm Red, Pantone Green, Pantone Orange 021, Pantone Blue 072, Pantone Red 032, Pantone Rhodamine Red, Pantone Violet, and Pantone Purple as well as clear toner was found in each case to be 29.0 μC/g, with a standard deviation of 9 μC/g, at 21° C. and 50% relative humidity. The optional additives in each of the 15 cases above was 1.7% RY50 silica from Nippon Aerosil, 0.74% X24 from Shin-Etsu Chemical Co. and 0.37% JMT2000 from Tayca, herein called additive design A.

Similarly, the triboelectric charge of developers made from emulsion aggregation toners was also found to be consistent across many colors. SCMB carrier, herein called carrier A, comprised of 35 micron ferrite core supplied by Powdertech was coated at 200° C. with 0.8 wt % of 75 parts PMMA by wt, 9 parts carbon black by wt, 10 parts melamine by wt and 6% kynar by wt. was added to emulsion aggregation toners of 35 different colored toners, including clear, 5% R330+1% PB 15:3, 7.2% PB15:3+1.8% PV2, 7% PB 15:3, 17% PY14, 3.2% PR:122+4.8% PR238, 8% PR:48.1, 13.3% PG7, 6% PB15:3+PV23, 8% PR122, 13% PY74, 15% PY74, 5.7% PB:15:3, 1.9% PB15:3, 12% PR48.1, 6% PR238+6% PR122, 2% PR81:3+0.5% PV3, 9% Alkali Blue, 8% PR81:2, 7% PY17, 12.5% PY17, 3.8% PB15:3, 15% PO36, 8% PR53:1, 6.4% PR48:1+1.6% PR22, 2.5% PV23, 13.3% PG7, 7% PB15:3, 10% PB15:3, 17% PY14, 8% PR:48.1, 10% PB15:3, 3.2% PR:122+4.8% PR238, 7.2% PB15:3+1.8% PV23, 8% PR169+PR122, where each toner again included optional additives, additive design A. The resulting mean triboelectric charge was found to be 26.4 μC/g, with a standard deviation of 4.5 μC/g, at 21° C. and 50% relative humidity. Therefore, developers made from emulsion aggregation toners of differing colors can successfully be mixed together, so long as each toner uses the same optional additives.

### Example 2

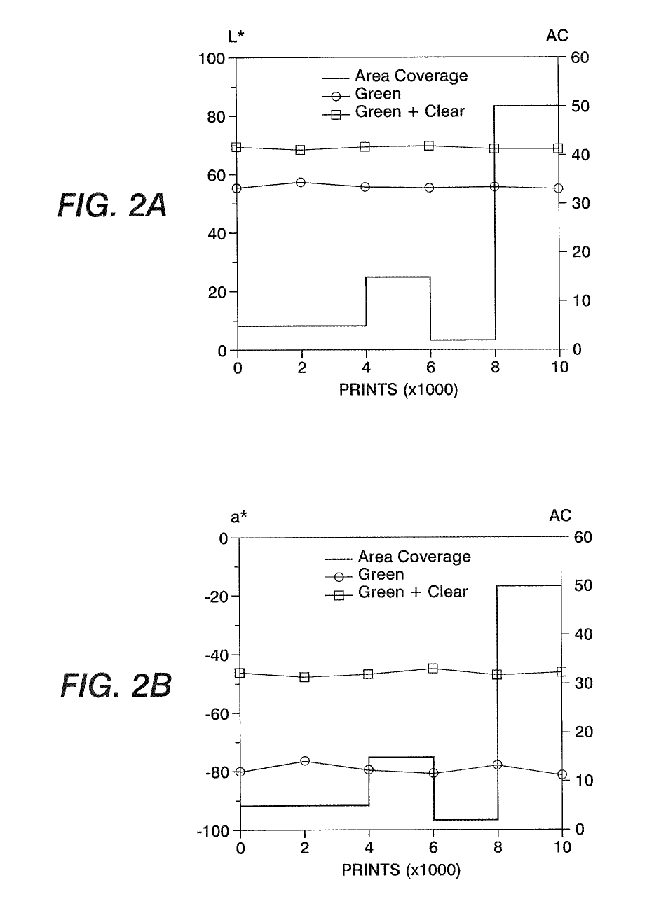

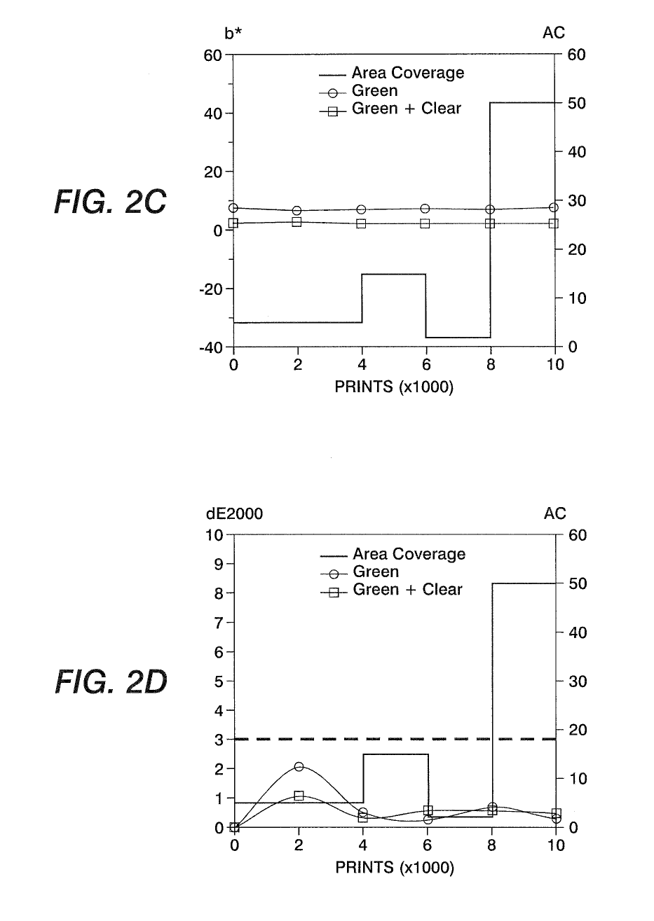

A 50:50 mixture of emulsion aggregation Pantone™ Green toner and emulsion aggregation clear toner both with additive design A were blended as a single developer with SCMB carrier A. A blended replenisher of the 50:50 toner blend with carrier A was also made, and a print test was run for 10,000 prints under varying area coverage stresses to test the color stability of the blend. Prints were fused off-line and the color of the prints were evaluated as L*a*b* values, from which a dE2000 was measured to quantitatively assess color drift. As seen in FIGS. 2A to 2D, the green/clear blended toner showed similar color variation as a single color green toner run under the same conditions. Therefore, FIGS. 2A to 2D show that a blend of a clear and a colorized toner can lead to a stable blended color developer that provides excellent color stability over the 10K print test. The total dE observed was less than 1 dE, well within the target of a total of 3 dE for color stability, so that no change of color is perceived on the print.

### Comparative Example 1

Two toners, an emulsion aggregation yellow toner prepared with 17% Pigment Yellow 14 and an emulsion aggregation blue toner prepared with 7% Pigment Blue 15.3 were selected that had different triboelectric charge. To produce the different charge in the emulsion aggregation yellow toner, a yellow pigment with a different type of pigment dispersant, an anionic surfactant, was selected. All other toners were prepared with Sun Flexiverse® pigments, which utilize an alkali stabilized acrylic resin. The change in dispersant resulted in a higher tribo charge for the yellow. Thus, the yellow toner was printed in a Xerox DC3535 and over a 10,000 print run showed an average tribo charge of 25.3 at 7% TC. In a second print test, the blue toner was printed over a 10,000 print run showing an average tribo charge of 18.8 at 7% TC. For a third print test the same emulsion aggregation yellow and blue toners, having individually different triboelectric charge, were mixed in a blend in a 1:1 ratio. Two toners having different colors were used in this Comparative Example, instead of a color toner and a clear toner, so that the results could readily be seen by visual inspection.

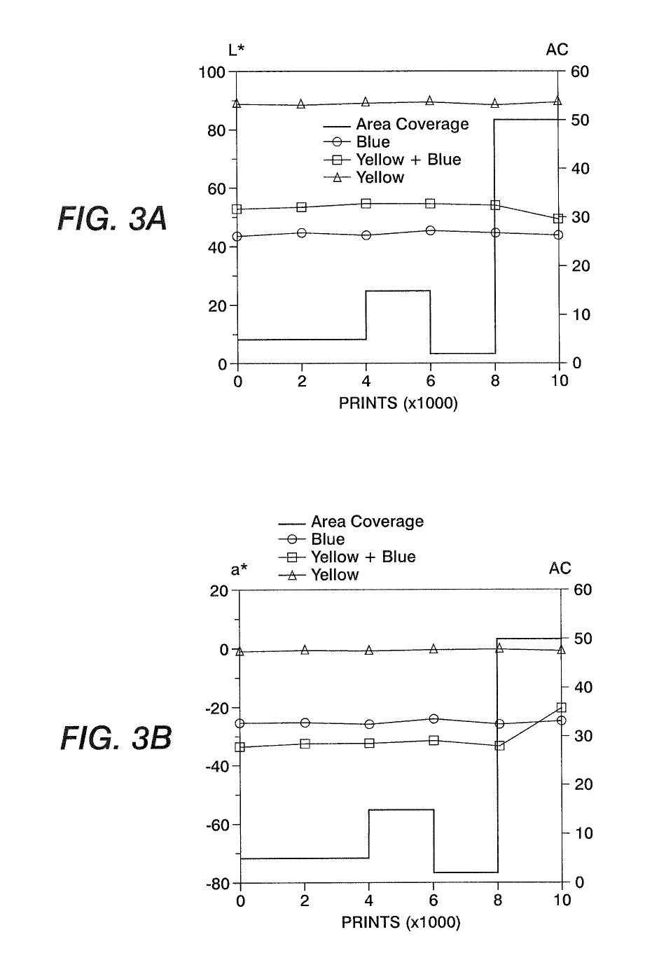

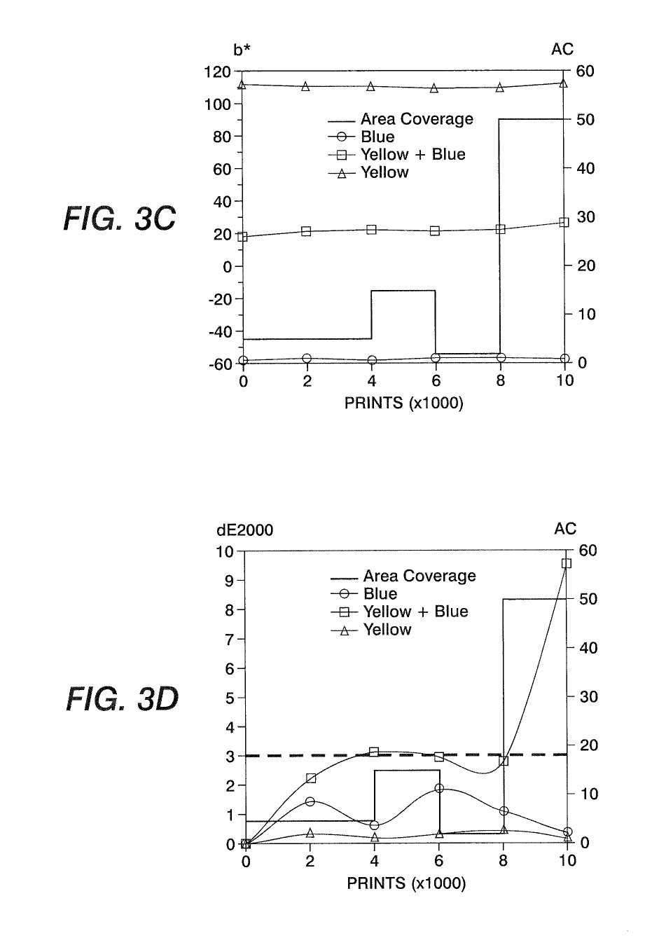

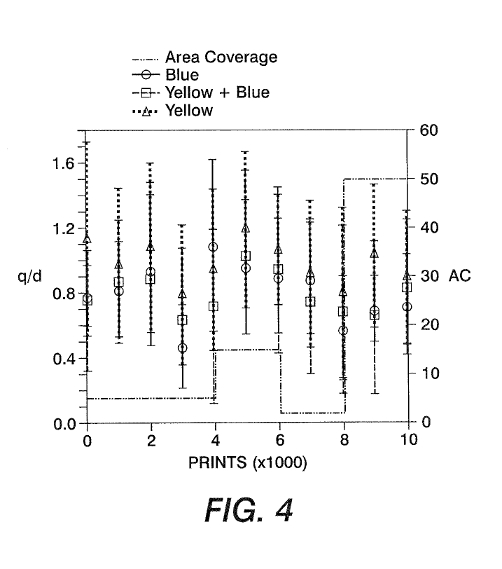

As shown in FIG. 4, the blue toner has a lower mean charge value than the yellow, so that when the two are mixed together the charge difference causes different charge distributions for the two colors. This can be seen in the q/d trace. As seen in FIGS. 3A to 3D, the two toners thus develop differently into the image, causing a color shift. Therefore, this Comparative Example shows that the two toners must have similar triboelectric charging properties in order to successfully mix them into a toner having a new color. It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

1-17. (canceled)

18. A method of printing an image comprising:
printing at least one first marking material on an area of a substrate, the at least one first making material comprising a first toner having a first hue; and
printing at least one second marking material on the same area of the substrate;
wherein the at least one second marking material comprises a mixture of at least a second and a third toner, where at least one of the second and third toners has a lower color strength than the first marking material, and the second marking material having a hue that is the same hue as the first hue; and
wherein a ratio of the second toner to the third toner in the second marking material results in the second marking material having a color strength matching that of an substantially noise inducing region of the toner reproduction curve of the first marking material.

19. The method of claim 18, wherein the substantially noise inducing region comprises a range from highlight to midtone.

20. The method of claim 18, wherein the substantially noise inducing region comprises a midtone region.

21. The method of claim 18, wherein the substantially noise inducing region comprises a peak noise range.

22. The method of claim 18, wherein the second and third toners are emulsion aggregation toners.

23. The method of claim 22, wherein the second and third toners are emulsion aggregation toners having a mean particle diameter of less than 7 microns.

24. The method of claim 18, wherein the first hue is selected from the group consisting of process cyan, process magenta, process yellow and process black.

25. The method of claim 18, wherein the image is a full color image.

26. The method of claim 18, wherein the first toner and the second toner are the same toner.

27. The method of claim 18, wherein the first toner and the second toner are different toners, having the same hue.

28. The method of claim 18, wherein the third toner is a lightly pigmented toner.

29. The method of claim 18, wherein the third toner is a clear toner.

30. The method of claim 18, wherein a triboelectric charge value of the second toner is substantially similar to a triboelectric charge value of the third toner.

31. The method of claim 18, wherein the first toner and the second toner comprise pigment particle colorants.

32. The method of claim 18, wherein the first toner and the second toner comprise dye colorants.

33. The method of claim 18, wherein the first marking material comprises a black toner printed from a first developer housing and the second marking material is printed from a second developer housing.

34. The method of claim 18, wherein the step of printing at least one first marking material comprises printing four first marking materials on four areas, optionally overlapping, of the substrate;
wherein the four first marking materials are printed from four separate developer housings, and the four first marking materials respectively comprise a cyan toner, a magenta toner, a yellow toner and a black toner; and
the second marking material is printed from a fifth separate developer housing, the second marking material having the same hue as one of the four first marking materials, and is printed on the same area of the substrate as that one first marking material.

35. The method of claim 18, wherein the step of printing at least one first marking material comprises printing four first marking materials on four areas, optionally overlapping, of the substrate;
wherein the four first marking materials are printed from four separate developer housings, and the four first marking materials respectively comprise a cyan toner, a magenta toner, a yellow toner and a black toner; and
the step of printing at least one second marking material comprises printing two second marking materials, the two second marking materials being printed from a fifth and a sixth separate developer housing respectively, the two second marking materials respectively having the same hue as two out of the four first making materials, and the two second marking materials are each respectively printed on the same area of the substrate as each of the two respective first marking material having the same hue.

36. The method of claim 18, wherein the step of printing at least one first marking material comprises printing four first marking materials on four areas, optionally overlapping, of the substrate;
wherein the four first marking materials are printed from four separate developer housings, and the four first marking materials respectively comprise a cyan toner, a magenta toner, a yellow toner and a black toner; and
the step of printing at least one second marking material comprises printing three second marking materials, the three second marking materials being printed from a fifth, a sixth and a seventh separate developer housing respectively, the three second marking materials respectively having the same hue as three out of the four first making materials, and the three second marking materials are each respectively printed on the same area of the substrate as each of the three respective first marking material having the same hue.

37. The method of claim 18, wherein the step of printing at least one first marking material comprises printing four first marking materials on four areas, optionally overlapping, of the substrate;
wherein the four first marking materials are printed from four separate developer housings, and the four first marking materials respectively comprise a cyan toner, a magenta toner, a yellow toner and a black toner; and
the step of printing at least one second marking material comprises printing four second marking materials, the four second marking materials being printed from a fifth, a sixth, a seventh and an eighth separate developer housing respectively, the four second marking materials respectively having the same hue as the four first making materials, and the four second marking materials are each respectively printed on the same area of the substrate as each of the four respective first marking material having the same hue.
